(19) United States
(12) Patent Application Publication
(10) Pub. No.: US 2007/0280173 A1
(43) Pub. Date: Dec. 6, 2007

(54) Method for Configuring Signals Corresponding to Adaptive Packet Format of Mimo-Wlan System

(75) Inventors: Jin-hee Jo, Suwon-si (KR); Kil-sik Ha, Anyang-si (KR); Yong-sik Kwon, Seoul (KR); Seok-hyun Yoon, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/581,396

(22) PCT Filed: Jun. 14, 2005
(86) PCT No.: PCT/KR05/01811

§ 371 Date: Mar. 16, 2007

(30) Foreign Application Priority Data
Jun. 14, 2004 (KR) 10-2004-0043696
Jun. 9, 2005 (KR) 10-2005-0049348

(51) Int. Cl. H04L 12/28

(52) U.S. Cl. 370/338

(57) ABSTRACT

Disclosed is a signal constructing method according to an adaptive packet format in a MIMO-WLAN (Multi-input multi-output Wireless LAN) system. A method is used to construct a plurality of signals in a MIMO-WLAN, with transmitting a data packet as a plurality of signals via a plurality of antennas. The method includes the steps of: constructing a data packet to include a preamble for packet transmission, an additional information region for data packet transmission in MIMO-WLAN system, and a service data unit; distributing data of the preamble to at least one of the plurality of signals; distributing data of the additional information region to at least one of the plurality of signals; and distributing data of the service data unit to at least one of the plurality of signals. The method is compatible with existing wireless LAN technology standard mode, and also provides high-speed data transmission rate.

### TECHNICAL FIELD

The present invention relates to a method for constructing signals in a Wireless Local Area Network system which Multiple Input Multiple Output (MIMO) is applied to (hereinafter, referred to as MIMO-WLAN), and more specifically to a method for configuring signals according to an adaptive packet format to be compatible with the existing WLAN system and increase a data trasmission rate using multiple antennas.

### BACKGROUND ART

The existing IEEE 802.11 WLAN supports a transmission rate of 2 Mbps in the 2.4 GHz Industrial, Scientific and Medical (ISM) band using Direct Sequence Spread Spectrum (DSSS), Frequency Hopping Spread Spectrum (FHSS) and Infrared (IR) methods. However, this standards can not satisfy need for an increasing high-speed trasmission rate so that the new physical layer standards of IEEE 802.11a and IEEE 802.11b were settled in 1999.

IEEE 802.11a adopted orthogonal frequency division multiplexing (OFDM) modulation system to overcome limit of direct sequence spread spectrum (DSSS) in the 5 GHz Unlicenced National Information Infrastructure (U-NII) band and achieve a higher-speed trasmission rate. Convolution encoders of ½, ⅔, and ¾ encoding rate are used for error-correction and binary phase-shift keying (BPSK), quadrature phase shift keying (QPSK), 16-quadrature amplitude modulation (16 QAM), and 64-quadrature amplitude modulation (64-QAM) are used for subcarrier modulation.

Accordingly, a high-speed variable trasmission rate of 6 Mbps to 54 Mbps is supported by combining the encoder and modulator depending on channel condition. In addition, IEEE 802.11a has a simple structure of 52 subcarriers for Ethernet-based service in indoor environments, takes short training time and enables simple equalization using OFDM system, and is strong against multipath interference.

FIG. 1 shows a frame format of a data packet for WLAN data transmission of IEEE 802.11a which adopted OFDM system.

The PHY protocol data units (PPDU) frame of IEEE 802.11a WLAN includes an OFDM Physical Layer Convergence Protocol (PLCP) preamble (Hereinafter, referred to as a preamble) section for synchronization, a OFDM PLCP header, the PHY sublayer service DATA unit (PSDU), tail bits and pad bits.

The preamble section for synchronization consists of short preamble of 10 short training symbols and long preamble of 2 long training symbols. The PLCP header consists of SIGNAL field and SERVICE field. Further, the SERVICE field, PSDU, tail bits and pad bits are defined as a data section.

The short preamble including 10 short training symbols is used for Auto Gain Control Convergence (AGC), timing acquisition and coarse frequency acquisition. The long preamble including 2 long training symbols is used for channel estimation and fine frequency acquisition, and has protection section to avoid adjacent symbol interference.

The PSDU including data for trasmission, SERVICE field of 16 bits for scrambler initialization, tail of 6 bits for making a convolutional encoder zero state and pad have plural symbols.

FIG. 2 shows bit allocation of SIGNAL field of FIG. 1. SIGNAL indicating a transmission rate and length of DATA section is one OFDM symbol of 24 bits which is ½ convolutional-encoded and BPSK-modulated. As shown in FIG. 2, the SIGNAL includes RATE of 4 bits, a reserved bit of fifth bit, LENGTH of 12 bits, parity for error-correction and tail of 6 bits.

A data packet having a frame format such as FIG. 1 in a general WLAN system according to IEEE 802.11a standards is transmitted at a maximum speed of 54 Mbps through one antenna.

Currently, MIMO technology that uses multiple transmission and reception antennas with IEEE 802.11a standards has been discussed in order to raise a transmission rate more. Efficiency of frequency and capacity of network link is expected to dramatically improve using multiple antennas in a transmitter and receiver through multiple transmission and reception antenna technology of MIMO and MIMO is receiving many attentions as the main technology for system environments requiring high-speed data transmission.

As described above, the maximum tranmission rate by the existing WLAN standards is 54 Mbps. However, as need for implementation of high-speed data transmission rate such as real-time transmission of high quality video is growing, the MIMO technology which increases data transmission capacity of a system using multiple transmission/reception antennas is being considered as a promising technology to increase trasmission capacity of WLAN.

Meanwhile, a new frame format of the data packet has to be designed to accommodate all of the increased transmission antennas in order to implement the MIMO-WLAN system and at this point the compatibility with systems following the existing WLAN standards has to be essentially considered.

That is, in order to apply the MIMO technology to WLAN of IEEE 802.11a, signals for transmission/reception through multiple antennas have to be constructed according to a new frame format for transmission of the data packet using multiple antennas. In addition, the data packet of the MIMO-WLAN system according to the new frame format and a method for constructing signals for transmission/reception of the packet have to be designed to be compatible with the existing IEEE 802.11a system and the method for transmission/reception.

### DISCLOSURE OF INVENTION

Technical Problem

An aspect of the present invention is to provide a method for constructing signals in MIMO-WLAN system to correct a frame format for data packet transmission in the MIMO-WLAN system to be compatible with the existing WLAN system and construct transmission/reception signals through multiple antennas according to the corrected adaptive frame format to implement a fast transmission rate.

Technical Solution

To achieve the above aspect, a method for constructing plural signals in the MIMO-WLAN system which transmits a data packet as the plural signals through multiple antennas according to the present invention comprises constructing a data packet to include a preamble for data packet transmission, a SIGNAL, an additional information section for data packet transmission of the MIMO-WLAN system and a service data unit, inserting data of the preamble and the SIGNAL in at least one of the plural signals, distributing data of the additional information section in at least one of the plural signals, and distributing data of the service data unit in at least one of the plural signals.

Preferably, the data of the additional information section includes information on the number of the plural signals of the MIMO-WLAN system.

Further, the data of the additional information section includes a trasmission method of the MIMO-WLAN system.

Further, the data of the additional information section includes a data transmission rate of the MIMO-WLAN system.

Preferably, the data of the additional information section includes a training signal for channel estimation of the MIMO-WLAN system.

Meanwhile, the step of constructing the data packet places the additional information section prior to the service data unit.

Further, the data of the SIGNAL includes LENGTH_N data to calculate time information for the data packet transmission according to the transmission rate of the MIMO-WLAN system.

Advantageous Effects

According to the present invention, as a frame format of a data packet of MIMO-WLAN having compatibility with WLAN standards based on OFDM loads MIMO information to a reserved bit of the SIGNAL field, the WLAN standard mode and MIMO mode can be easily compatible each other. Additionally, as the MIMO information is transmitted through the SIGNAL field, a receiver can rapidly figure out a transmission signal mode.

Furthermore, MIMO additional information is inserted after SIGNAL field of a data packet so that necessary information for implementation of the MIMO-WLAN system can be transmitted, and LENGTH included in the SIGNAL field can be properly altered according to a transmission rate and the amount of additional information so that compatibility with the existing WLAN system can be guaranteed.

Meanwhile, each transmission antenna transmits long preamble, which is used in the existing WLAN system, in time division method so that a receiver of the MIMO system equally applies channel estimation method used in the existing WLAN system and can sequentially estimate channels of each transmission antenna.

Therefore, the method according to the present invention is compatible with the existing WLAN standard mode and implements a high-speed data transmission rate so that the method can be applied to services such as real time transmission of high-quality video.

### BRIEF DESCRIPTION OF THE DRAWINGS

FIG. 1 is a view to show a frame format of a data packet of a general WLAN system,

FIG. 2 is a view to describe bit allocation of the SIGNAL field of FIG. 1,

FIG. 3 is a view to show a frame format of a data packet to construct a transmission signal in a MIMO-WLAN system according to an embodiment of the present invention,

FIG. 4 is a view to describe bit allocation of the SIGNAL section of FIG. 3,

FIG. 5 is a view to show a frame format of a data packet to configure a transmission signal in a MIMO-WLAN system according to another embodiment of the present invention, and

FIG. 6 is a view to show a frame format of a data packet to configure a transmission signal in a MIMO-WLAN system according to another embodiment of the present invention.

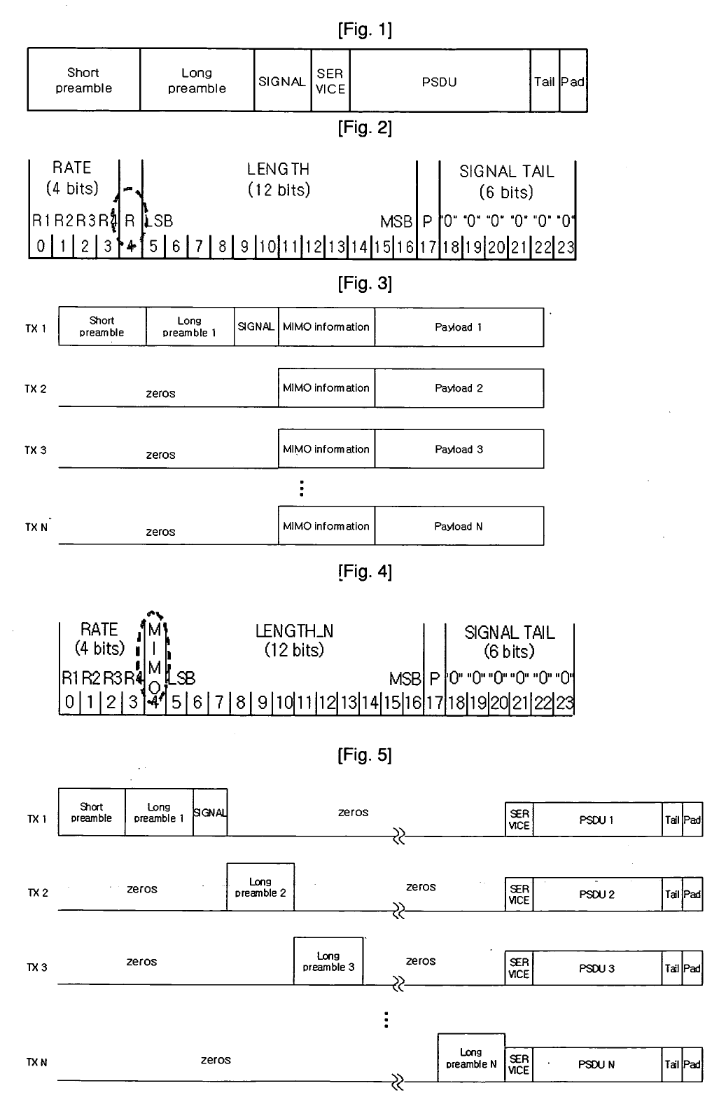

### BEST MODE FOR CARRYING OUT THE INVENTION

Hereinafter, a method for constructing signals in the MIMO-WLAN system according to the present invention is described with reference to the accompanying drawings.

FIG. 3 shows a frame format of a data packet to construct signals in the MIMO-WLAN system according to an embodiment of the present invention and FIG. 4 is a view to describe bit allocation of the SIGNAL field of FIG. 3.

FIG. 3 shows a frame format of a data packet of the MIMO system which is transmitted and received through multiple antennas. The data packet frame in the MIMO system is distributed in plural signals through multiple antennas and transmitted, and the signals to be transmitted through each antenna are refered to as the first transmission signal to the Nth transmission signal (TX1 to TXN).

TX1 has a similar structure to a frame format used in the existing WLAN system, consists of short preamble, long preamble 1, SIGNAL field and payload1 including data to be transmitted, and further includes MIMO additional information field including information on MIMO system between the SIGNAL field and payload unlike the existing system. The additional information field will be described below in detail.

Further, TX2, TX3 . . . and TXN unlike TX1 consist of MIMO additional information field and payload2 . . . and payload N, and do not have short preamble, long preamble and SIGNAL field.

TX2, TX3 . . . and TXN has values of 0 (zero) during the short preamble, long preamble and SIGNAL section of TX1. That is, while an antenna is transmitting preamble and SIGNAL, the rest of the antennas transmits ‘0’ (zero) signals not to transmit signals so that the WLAN system following the existing standards can interpret signals as well.

Meanwhile, a method for constructing signals in the MIMO-WLAN system according to an embodiment of the present invention instructs MIMO extension using a reserved bit of the SIGNAL field of TX1. The embodiment of the present invention loads MIMO information in the reserved bit and suggests a structure of a frame format of MIMO-WLAN to be compatible with 802.11a.

Referring to FIG. 4, the fifth reserved bit of SIGNAL field of TX1 according to the embodiment of the present invention is allocated as a bit to determine a MIMO mode, and for instance, if it is ‘0’, it is instructed that a signal with a frame format of WLAN standards is transmitted, and if it is ‘1’, it is instructed that a signal with a frame format of new MIMO-WLAN system is transmitted. The suggested structure to construct MIMO information in the embodiment is just an example and various other structures can be considered.

If a bit to instruct MIMO extension is set, a section to transmit additional information for the extended MIMO-WLAN system is placed between SIGNAL and DATA. The additional information section may include the number of transmission antennas, a modulation method, a transmission method such as an encoding rate on channel coding, MIMO-WLAN system information such as a data transmission rate and a training signal for MIMO channel estimation. Therefore, a receiver of the MIMO-WLAN system can get necessary information.

If a bit to instruct MIMO extension is not set, that is, the fifth reserved bit of SIGNAL of TX1 is ‘0’, TX1 having the same kind of preamble and SIGNAL as those of the existing WLAN system is transmitted via one transmission antenna and other antennas transmit ‘0’ (zero) signal not to transmit any signal.

Therefore, the existing WLAN system understands data transmitted from the MIMO-WLAN system in the same method as transmission data of the existing WLAN system so that the MIMO-WLAN system using multiple transmission/reception antennas are compatible with the existing WLAN system.

Furthermore, according to an increased data transmission rate by insertion of an additional information section and MIMO extension, LENGTH included in SIGNAL is altered to LENGTH_N and the existing WLAN system can estimate a duration section of MIMO-WLAN frames so that compatibility of the MIMO-WLAN system can be maintained.

Meanwhile, the WLAN system using Carrier Sense Multiple Access With Collision Avoidance (CSMA/CA), which is a multiple access method, needs to estimate a section where surrounding WLAN system transmits data. Therefore, the signal duration section of the existing WLAN system needs to be estimated through the transmission signal in order for the MIMO-WLAN system according to the present invention to be compatible with the existing WLAN system.

Therefore, LENGTH information included in SIGNAL of a frame format of the MIMO-WLAN system has to be properly altered according to an actual transmission rate and be transmitted. For example, if a data transmission rate of the MIMO-WLAN system is ‘T’ times as high as that of the existing WLAN system which is indicated in RATE, actual data transmission time becomes ‘1/T’ times. Additionally, as additional information used in the MIMO-WLAN system is additionally inserted, time information for the additional information section has to be included. Accordingly, the altered LENGTH_N can be expressed as in Equation 1.
LENGTH.N−(LENGTH/T)+(M*N_{DBPS}/8) [Equation 1]

where, ‘M’ indicates an additional information section as the number of OFDM symbols and N_{DBPS} indicates the number of bits per OFDM symbol corresponding to RATE, which is prescribed in the existing WLAN standards.

FIG. 5 shows a frame format of MIMO-WLAN data packet according to another embodiment of the present invention. In the embodiment, each antenna in the additional information section transmits long preamble in time division method for channel estimation of a transmitted signal in the MIMO-WLAN system. That is, when one antenna transmits long preamble in the addtional information section, the rest of the antennas do not transmit signals.

Referring to FIG. 5, TX1 consists of short preamble, long preamble 1, SIGNAL field, SERVICE field, PSDU1, tail and pad.

As above-mentioned referring to FIG. 4, in another embodiment, the fifth reserved bit of SIGNAL field of TX1 is allocated to a bit for MIMO mode estimation. When the reserved bit is ‘0’, IEEE 802.11a mode is operated, and when it is ‘1’, MIMO mode is operated.

Further, TX2˜TXN in FIG. 5 consist of long preamble (long preamble 2˜long preamble N), SERVICE field, PSDU2, tail and pad, and do not include short preamble and SIGNAL field unlike TX1. Instead, TX2˜TSN have value of ‘0’ during sections of short preamble, long preamble and SIGNAL of TX1. Namely, while one antenna transmits preamble and SIGNAL, the rest of the antennas are constructed not to transmit signals, in other words, to transmit ‘0(zeros)’ signals so that the existing WLAN system can interpret the signals.

Meanwhile, TX1 transmits a ‘0’ signal during long preamble sections of TX2˜TXN. long preamble field informs channel information of each transmitted signal via multiple antennas and TX2˜TXN as well has ‘0’ during long preamble section of other TXs to prevent each long preamble signal from being mixed. Accordingly, TX1˜TXN respectively has ‘0’ during long preamble section of other TXs.

As above-described referring to FIG. 4, long preambles are inserted in TX2˜TXN so that LENGTH of DATA of entire transmission signals is lengthened. As a result, LENGTH of SIGNAL field is converted into LENGTH_N which is added with length of long preamble of TX2˜TXN to LENGTH of DATA of a transmission signal according to IEEE 802.11a.

Meanwhile, according to IEEE 802.11a, there are 32 protection sections before 2 symbols until long preamble, but there are 16 protection sections per symbol from SIGNAL so that preferably, there may be 16 protection sections per training symbol in long preamble of TX2˜TXN transmitted after SIGNAL field to be easily compatible with IEEE 802.11a.

To operate the MIMO-WLAN system, MIMO channel estimation is essential. The existing WLAN system can estimate channels using long preamble but the MIMO-LAN sysem needs to estimate channels of each transmission antenna due to an increase of transmission antennas.

Therefore, each transmission antenna transmits the long preamble used in the existing WLAN system to the additional information section in time division method in another embodiment according to the present invention. That is, when one antenna transmits long preamble, the rest of the antennas transmits ‘0(zeros)’, so that a transmitter can sequentially estimate channels of each transmission antenna in the same method as the channel estimation method in the existing WLAN system.

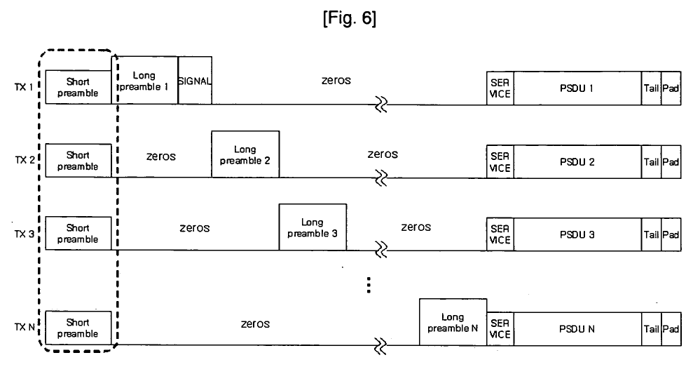

FIG. 6 shows a frame format of a data packet of the MIMO-WLAN system according to another embodiment of the present invention.

For AGC, each transmission antenna tranmits short preamble to effectively estimate the size of a signal received to a receiver under MIMO extension environments of the MIMO-WLAN system.

In this case, each short preamble uses the same signal as short preamble prescribed in the existing WLAN standards or a cyclic-shifted signal so that the existing WLAN system can recognize short preamble of the MIMO-WLAN system.

Generally, a receiver in the existing WLAN sysem performs AGC using short preamble. A receiver in the MIMO-WLAN system has to perform AGC of the sum of signals transmitted from the entire transmission antennas.

If AGC is performed using short preamble transmitted from one transmission antenna, the size of signals generated from DATA section where the entire transmission antennas transmit signals can not be properly reflected. Accordingly, the entire signals transmitted through each transmission antenna are constructed to include short preamble in another embodiment according to the present invention so that a receiver performs AGC of the sum of signals received at the entire reception antennas.

Short preambles transmitted from each transmission antenna may use the same signal as necessary, or otherwise, may use differently cyclic-shifted signal. In this case, as repeatability of a signal is maintained, the existing WLAN system can still recognize short preamble.

Meanwhile, short preamble in TX1˜TXN may preferably be transmitted in lower electric power than that of the transmission signal according to IEEE 802.11a for convenience of AGC. For example, if TX1 and TX2 are transmitted through two antennas, short preamble respectively is transmitted in half of the transmission electric power according to IEEE 802.11a using the two antennas.

Therefore, as a signal in the above example is divided into two parts and transmitted through 2 antennas, the maximum of a transmission rate can be 108 Mbps, which is two times as much as 54 Mbps of the maximum of a transmission rate of IEEE 802.11a

Further, MIMO mode or IEEE 802.11a mode can be easily converted according to a method of allocating MIMO information to the SIGNAL field.

That is, in the above method, when the MIMO bit is ‘0’, the IEEE 802.11a mode is operated, and when MIMO bit is ‘1’, the MIMO mode is operated. As the electric power of TX1 and TX2 respectively of short preamble which is firstly transmitted in the MIMO mode is the half in the above example, the added electric power of the two signals in a receiver has the same value as that of IEEE 802.11a

In addition, in the case of MIMO mode, as the signals transmitted through antennas pass through different paths, TX1 and TX2 in the above example transmits long preamble in a different point of time respectively, and a receiver estimates channels of each path using the received long preamble respectively.

In this case, long preamble2 of TX2 trasmitted after the SIGNAL field is inserted with 16 protection sections per symbol unlike long preamble of TX1 inserted with 32 protection sections before two symbols so that the reception method of IEEE 802.11a can be equally used.

According to the present invention, MIMO information is loaded in the reserved bit of SIGNAL of the frame format of the MIMO-OFDM WLAN to be compatible with the WLAN system based on OFDM, so that the WLAN standard mode and MIMO mode can be easily compatible with each other.

Additionally, as MIMO information is transmitted through the SIGNAL field, the receiver can figure out the transmission signal mode fast and easily. And MIMO additional information is inserted after SIGNAL so that necessary information for MIMO-WLAN system implementation can be transmitted, and LENGTH included in SIGNAL is properly altered according to a transmission rate and the amount of additional information, so that compatibility with the existing WLAN system can be guaranteed.

Meanwhile, each transmission antenna transmits long preamble used in the exsting WLAN system in time division method and receiver of MIMO-WLAN system applies channel estimation method used in the existing WLAN system so that channels of each transmission antenna can be sequentially estimated.

Further, each transmission antenna transmits short preamble in the same form or cyclic-shifted form so that the receiver estimates size of the sum of signals transmitted from all of the antennas and performs AGC. As a result, effective AGC can be performed in DATA section where multiple antennas simultaneously transmit signals.

### MODE OF THE INVENTION

Hereinafter, a method for constructing signals in the MIMO-WLAN system according to the present invention is described with reference to the accompanying drawings.

FIG. 3 shows a frame format of a data packet to construct signals in the MIMO-WLAN system according to an embodiment of the present invention and FIG. 4 is a view to describe bit allocation of the SIGNAL field of FIG. 3.

FIG. 3 shows a frame format of a data packet of the MIMO system which is transmitted and received through multiple antennas. The data packet frame in the

MIMO system is distributed in plural signals through multiple antennas and transmitted, and the signals to be transmitted through each antenna are refered to as the first transmission signal to the Nth transmission signal (TX1 to TXN).

TX1 has a similar structure to a frame format used in the existing WLAN system, consists of short preamble, long preamble 1, SIGNAL field and payload1 including data to be transmitted, and further includes MIMO additional information field including information on MIMO system between the SIGNAL field and payload unlike the existing system. The additional information field will be described below in detail.

Further, TX2, TX3 . . . and TXN unlike TX1 consist of MIMO additional information field and payload2 . . . and payload N, and do not have short preamble, long preamble and SIGNAL field.

TX2, TX3 . . . and TXN has values of 0 (zero) during the short preamble, long preamble and SIGNAL section of TX1. That is, while an antenna is transmitting preamble and SIGNAL, the rest of the antennas transmits ‘0’ (zero) signals not to transmit signals so that the WLAN system following the existing standards can interpret signals as well.

Meanwhile, a method for constructing signals in the MIMO-WLAN system according to an embodiment of the present invention instructs MIMO extension using a reserved bit of the SIGNAL field of TX1. The embodiment of the present invention loads MIMO information in the reserved bit and suggests a structure of a frame format of MIMO-WLAN to be compatible with 802.11a

Referring to FIG. 4, the fifth reserved bit of SIGNAL field of TX1 according to the embodiment of the present invention is allocated as a bit to determine a MIMO mode, and for instance, if it is ‘0’, it is instructed that a signal with a frame format of WLAN standards is transmitted, and if it is ‘1’, it is instructed that a signal with a frame format of new MIMO-WLAN system is transmitted. The suggested structure to construct MIMO information in the embodiment is just an example and various other structures can be considered.

If a bit to instruct MIMO extension is set, a section to transmit additional information for the extended MIMO-WLAN system is placed between SIGNAL and DATA. The additional information section may include the number of transmission antennas, a modulation method, a transmission method such as an encoding rate on channel coding, MIMO-WLAN system information such as a data transmission rate and a training signal for MIMO channel estimation. Therefore, a receiver of the MIMO-WLAN system can get necessary information.

If a bit to instruct MIMO extension is not set, that is, the fifth reserved bit of SIGNAL of TX1 is ‘0’, TX1 having the same kind of preamble and SIGNAL as those of the existing WLAN system is transmitted via one transmission antenna and other antennas transmit ‘0’ (zero) signal not to transmit any signal.

Therefore, the existing WLAN system understands data transmitted from the MIMO-WLAN system in the same method as transmission data of the existing WLAN system so that the MIMO-WLAN system using multiple transmission/reception antennas are compatible with the existing WLAN system.

Furthermore, according to an increased data transmission rate by insertion of an additional information section and MIMO extension, LENGTH included in SIGNAL is altered to LENGTH_N and the existing WLAN system can estimate a duration section of MIMO-WLAN frames so that compatibility of the MIMO-WLAN system can be maintained.

Meanwhile, the WLAN system using Carrier Sense Multiple Access With Collision Avoidance (CSMA/CA), which is a multiple access method, needs to estimate a section where surrounding WLAN system transmits data. Therefore, the signal duration section of the existing WLAN system needs to be estimated through the transmission signal in order for the MIMO-WLAN system according to the present invention to be compatible with the existing WLAN system.

Therefore, LENGTH information included in SIGNAL of a frame format of the MIMO-WLAN system has to be properly altered according to an actual transmission rate and be transmitted. For example, if a data transmission rate of the MIMO-WLAN system is ‘T’ times as high as that of the existing WLAN system which is indicated in RATE, actual data transmission time becomes ‘1/T’ times. Additionally, as additional information used in the MIMO-WLAN system is additionally inserted, time information for the additional information section has to be included. Accordingly, the altered LENGTH_N can be expressed as in Equation 1.
LENGTH.N−(LENGTH/T)+(M*N_{DBPS}/8) [Equation 1]

where, ‘M’ indicates an additional information section as the number of OFDM symbols and N_{DBPS} indicates the number of bits per OFDM symbol corresponding to RATE, which is prescribed in the existing WLAN standards.

FIG. 5 shows a frame format of MIMO-WLAN data packet according to another embodiment of the present invention. In the embodiment, each antenna in the additional information section transmits long preamble in time division method for channel estimation of a transmitted signal in the MIMO-WLAN system. That is, when one antenna transmits long preamble in the addtional information section, the rest of the antennas do not transmit signals.

Referring to FIG. 5, TX1 consists of short preamble, long preamble 1, SIGNAL field, SERVICE field, PSDU1, tail and pad.

As above-mentioned referring to FIG. 4, in another embodiment, the fifth reserved bit of SIGNAL field of TX1 is allocated to a bit for MIMO mode estimation. When the reserved bit is ‘0’, IEEE 802.11a mode is operated, and when it is ‘1’, MIMO mode is operated.

Further, TX2˜TXN in FIG. 5 consist of long preamble (long preamble 2˜long preamble N), SERVICE field, PSDU2, tail and pad, and do not include short preamble and SIGNAL field unlike TX1. Instead, TX2˜TSN have value of ‘0’ during sections of short preamble, long preamble and SIGNAL of TX1. Namely, while one antenna transmits preamble and SIGNAL, the rest of the antennas are constructed not to transmit signals, in other words, to transmit ‘0(zeros)’ signals so that the existing WLAN system can interpret the signals.

Meanwhile, TX1 transmits a ‘0’ signal during long preamble sections of TX2˜TXN. long preamble field informs channel information of each transmitted signal via multiple antennas and TX2˜TXN as well has ‘0’ during long preamble section of other TXs to prevent each long preamble signal from being mixed. Accordingly, TX1˜TXN respectively has ‘0’ during long preamble section of other TXs.

As above-described referring to FIG. 4, long preambles are inserted in TX2˜TXN so that LENGTH of DATA of entire transmission signals is lengthened. As a result, LENGTH of SIGNAL field is converted into LENGTH_N which is added with length of long preamble of TX2˜TXN to LENGTH of DATA of a transmission signal according to IEEE 802.11a

Meanwhile, according to IEEE 802.11a, there are 32 protection sections before 2 symbols until long preamble, but there are 16 protection sections per symbol from SIGNAL so that preferably, there may be 16 protection sections per training symbol in long preamble of TX2˜TXN transmitted after SIGNAL field to be easily compatible with IEEE 802.11a.

To operate the MIMO-WLAN system, MIMO channel estimation is essential. The existing WLAN system can estimate channels using long preamble but the MIMO-LAN sysem needs to estimate channels of each transmission antenna due to an increase of transmission antennas.

Therefore, each transmission antenna transmits the long preamble used in the existing WLAN system to the additional information section in time division method in another embodiment according to the present invention. That is, when one antenna transmits long preamble, the rest of the antennas transmits ‘0(zeros)’, so that a transmitter can sequentially estimate channels of each transmission antenna in the same method as the channel estimation method in the existing WLAN system.

FIG. 6 shows a frame format of a data packet of the MIMO-WLAN system according to another embodiment of the present invention.

For AGC, each transmission antenna tranmits short preamble to effectively estimate the size of a signal received to a receiver under MIMO extension environments of the MIMO-WLAN system.

In this case, each short preamble uses the same signal as short preamble prescribed in the existing WLAN standards or a cyclic-shifted signal so that the existing WLAN system can recognize short preamble of the MIMO-WLAN system.

Generally, a receiver in the existing WLAN sysem performs AGC using short preamble. A receiver in the MIMO-WLAN system has to perform AGC of the sum of signals transmitted from the entire transmission antennas.

If AGC is performed using short preamble transmitted from one transmission antenna, the size of signals generated from DATA section where the entire transmission antennas transmit signals can not be properly reflected. Accordingly, the entire signals transmitted through each transmission antenna are constructed to include short preamble in another embodiment according to the present invention so that a receiver performs AGC of the sum of signals received at the entire reception antennas.

Short preambles transmitted from each transmission antenna may use the same signal as necessary, or otherwise, may use differently cyclic-shifted signal. In this case, as repeatability of a signal is maintained, the existing WLAN system can still recognize short preamble.

Meanwhile, short preamble in TX1˜TXN may preferably be transmitted in lower electric power than that of the transmission signal according to IEEE 802.11a for convenience of AGC. For example, if TX1 and TX2 are transmitted through two antennas, short preamble respectively is transmitted in half of the transmission electric power according to IEEE 802.11a using the two antennas.

Therefore, as a signal in the above example is divided into two parts and transmitted through 2 antennas, the maximum of a transmission rate can be 108 Mbps, which is two times as much as 54 Mbps of the maximum of a transmission rate of IEEE 802.11a

Further, MIMO mode or IEEE 802.11a mode can be easily converted according to a method of allocating MIMO information to the SIGNAL field.

That is, in the above method, when the MIMO bit is ‘0’, the IEEE 802.11a mode is operated, and when MIMO bit is ‘1’, the MIMO mode is operated. As the electric power of TX1 and TX2 respectively of short preamble which is firstly transmitted in the MIMO mode is the half in the above example, the added electric power of the two signals in a receiver has the same value as that of IEEE 802.11a

In addition, in the case of MIMO mode, as the signals transmitted through antennas pass through different paths, TX1 and TX2 in the above example transmits long preamble in a different point of time respectively, and a receiver estimates channels of each path using the received long preamble respectively.

In this case, long preamble2 of TX2 trasmitted after the SIGNAL field is inserted with 16 protection sections per symbol unlike long preamble of TX1 inserted with 32 protection sections before two symbols so that the reception method of IEEE 802.11a can be equally used.

According to the present invention, MIMO information is loaded in the reserved bit of SIGNAL of the frame format of the MIMO-OFDM WLAN to be compatible with the WLAN system based on OFDM, so that the WLAN standard mode and MIMO mode can be easily compatible with each other.

Additionally, as MIMO information is transmitted through the SIGNAL field, the receiver can figure out the transmission signal mode fast and easily. And MIMO additional information is inserted after SIGNAL so that necessary information for MIMO-WLAN system implementation can be transmitted, and LENGTH included in SIGNAL is properly altered according to a transmission rate and the amount of additional information, so that compatibility with the existing WLAN system can be guaranteed.

Meanwhile, each transmission antenna transmits long preamble used in the exsting WLAN system in time division method and receiver of MIMO-WLAN system applies channel estimation method used in the existing WLAN system so that channels of each transmission antenna can be sequentially estimated.

Further, each transmission antenna transmits short preamble in the same form or cyclic-shifted form so that the receiver estimates size of the sum of signals transmitted from all of the antennas and performs AGC. As a result, effective AGC can be performed in DATA section where multiple antennas simultaneously transmit signals.

1. A method for constructing plural signals in the MIMO-WLAN system which transmits a data packet as the plural signals through multiple antennas, comprising:
constructing a data packet to include a preamble for data packet transmission, a SIGNAL, an additional information section for data packet transmission of the MIMO-WLAN system and a service data unit;
distributing data of the preamble and the SIGNAL in at least one of the plural signals;
distributing data of the additional information section in at least one of the plural signals; and
distributing data of the service data unit in at least one of the plural signals.

2. The method as claimed in claim 1, wherein the data of the additional information section includes information on the number of the plural signals of the MIMO-WLAN system.

3. The method as claimed in claim 1, wherein the data of the additional information section includes a trasmission method of the MIMO-WLAN system.

4. The method as claimed in claim 1, wherein the data of the additional information section includes a data transmission rate of the MIMO-WLAN system.

5. The method as claimed in claim 1, wherein the data of the additional information section includes a training signal for channel estimation of the MIMO-WLAN system.

6. The method as claimed in claim 1, wherein the step of constructing the data packet places the additional information section prior to the service data unit.

7. The method as claimed in claim 1, wherein the data of the SIGNAL includes LENGTH_N data to calculate time information for the data packet transmission according to the transmission rate of the MIMO-WLAN system.
